(19) United States
(12) Patent Application Publication
(10) Pub. No.: US 2026/0080828 A1
(43) Pub. Date: Mar. 19, 2026

(54) DISPLAY PANEL AND ELECTRONIC DEVICE INCLUDING THE SAME

(71) Applicant: Samsung Display Co., Ltd., Yongin-si (KR)

(72) Inventor: KEUNWOO KIM, Yongin-si (KR)

(21) Appl. No.: 19/321,028

(22) Filed: Sep. 5, 2025

(30) Foreign Application Priority Data
Sep. 13, 2024 (KR) 10-2024-0125456

(51) Int. Cl. G09G 3/3233; G09G 3/32

(52) U.S. Cl. CPC G09G 3/3233; G09G 3/32; G09G 2300/0819; G09G 2320/0271; G09G 2330/021

(57) ABSTRACT

A display panel in accordance with one or more embodiments of the present disclosure includes a first pixel including a first light-emitting diode, and a first pixel circuit including a first driving transistor electrically connected to the first light-emitting diode, and including a first input electrode, a first output electrode, a first control electrode, and a first sub-control electrode, and a first main light-emission transistor connected in series with the first driving transistor, and configured to be controlled by a first control signal, and a second pixel including a second light-emitting diode, and a second pixel circuit including a second driving transistor electrically connected to the second light-emitting diode, and including a second input electrode, a second output electrode, a second control electrode, and a second sub-control electrode configured to receive the first control signal, and a second main light-emission transistor connected in series with the second driving transistor.

### CROSS-REFERENCE TO RELATED APPLICATION

The present application claims priority to, and the benefit of, Korean Patent Application No. 10-2024-0125456, filed on Sep. 13, 2024, in the Korean Intellectual Property Office, the entire disclosure of which is incorporated herein by reference.

### BACKGROUND

### 1. Field

The present disclosure relates to a display panel with an expanded driving range for the driving transistor and enhanced low-gray-scale display capability, as well as an electronic device incorporating such a display panel.

### 2. Description of the Related Art

A display panel typically includes a driving transistor and a light-emitting diode. The brightness of light emitted from the light-emitting diode is controlled by the output signal of the driving transistor. The driving range of the driving transistor refers to the range of input signals required to be input to produce an output signal corresponding to a specific range.

When the driving range corresponding to low-gray-scale display (hereinafter referred to as “low-gray-scale driving range”) is expanded, the output signal of the driving transistor for low-gray-scale display can be more precisely controlled. Accordingly, the low-gray-scale display capability of the display panel and the electronic device incorporating the display panel can be enhanced.

Generally, the physical properties of the driving transistor may be modified to expand the low-gray-scale driving range. However, this approach has the shortcoming of increased power consumption of the driving transistor.

### SUMMARY

The present disclosure provides a display panel, and an electronic device including the same, in which the low-gray-scale driving range is expanded, and in which low-gray-scale display capability is enhanced, without increasing power consumption, by applying an electrical signal to the back-gate electrode of the driving transistor, rather than by altering the physical properties of the driving transistor.

A display panel according to one or more embodiments of the present disclosure may include a first pixel including a first light-emitting diode, and a first pixel circuit including a first driving transistor electrically connected to the first light-emitting diode, and including a first input electrode, a first output electrode, a first control electrode, and a first sub-control electrode, and a first main light-emission transistor connected in series with the first driving transistor, and configured to be controlled by a first control signal, and a second pixel including a second light-emitting diode, and a second pixel circuit including a second driving transistor electrically connected to the second light-emitting diode, and including a second input electrode, a second output electrode, a second control electrode, and a second sub-control electrode configured to receive the first control signal, and a second main light-emission transistor connected in series with the second driving transistor.

The first pixel may further include a first data line configured to provide a first data signal, wherein the second pixel further includes a second data line configured to provide a second data signal, wherein the first pixel circuit and the second pixel circuit further include a first switching transistor and a second switching transistor, respectively, wherein the second switching transistor is between the second data line and the second control electrode, and wherein a potential of the first control signal is configured to change from a first value to a second value between a time when the second switching transistor is turned on and a time when the second main light-emission transistor is turned on.

The first pixel may further include a first main power line configured to provide a first main power signal, and wherein the first main light-emission transistor is between the first driving transistor and the first main power line, or between the first driving transistor and the first light-emitting diode.

The first main light-emission transistor may be between the first driving transistor and the first light-emitting diode, wherein the first pixel circuit further includes a first sub-light-emission transistor between the first driving transistor and the first main power line.

The first main light-emission transistor may be between the first driving transistor and the first main power line, wherein the first pixel circuit further includes a first sub-light-emission transistor between the first driving transistor and the first light-emitting diode.

The second pixel may further include a second main power line configured to provide a second main power signal, wherein the first pixel circuit further includes a first stabilization capacitor, and wherein the second pixel circuit further includes a second stabilization capacitor between an electrode of the second driving transistor and the second main power line.

The first pixel may further include an initialization line configured to provide a first initialization control signal, wherein the second pixel further includes a second initialization line configured to provide a second initialization signal, wherein the first pixel circuit further includes a first initialization transistor, wherein the second pixel circuit further includes a second initialization transistor between the second initialization line and the second light-emitting diode.

The first pixel circuit may further include a first compensation capacitor, wherein the second pixel circuit further includes a second compensation capacitor between the second output electrode and the second control electrode of the second driving transistor.

The first pixel may further include a first reference voltage line configured to provide a first reference voltage signal, wherein the second pixel further includes a second reference voltage line configured to provide a second reference voltage signal, wherein the first pixel circuit further includes a first compensation transistor, and wherein the second pixel circuit further includes a second compensation transistor between the second reference voltage line and the second compensation capacitor.

The display panel may further include a third pixel including a third light-emitting diode, and a third pixel circuit including a third driving transistor electrically connected to the third light-emitting diode, and including a third input electrode, a third output electrode, a third control electrode, and a third sub-control electrode configured to receive a second control signal, and a third main light-emission transistor connected in series with the third driving transistor, wherein the first pixel further includes a first main power line configured to provide a first main power signal, wherein the second pixel further includes a second main power line configured to provide a second main power signal, wherein the first main light-emission transistor is between the first driving transistor and the first light-emitting diode, and wherein the second main light-emission transistor is between the second driving transistor and the second main power line, and is configured to be controlled by the second control signal.

The first pixel may further include a first data line configured to provide a first data signal, wherein the second pixel further includes a second data line configured to provide a second data signal, wherein the third pixel further includes a third data line configured to provide a third data signal, wherein the first pixel circuit further includes a first switching transistor, wherein the second pixel circuit further includes a second switching transistor, wherein the third pixel circuit further includes a third switching transistor between the third data line and the third control electrode, and wherein a potential of the second control signal is configured to be changed from a third value to a fourth value between a time when the third switching transistor is turned on and a time when the third main light-emission transistor is turned on.

The third pixel may further include a third main power line configured to provide a third main power signal, wherein the third main light-emission transistor is between the third driving transistor and the third main power line, and wherein the third pixel circuit further includes a third sub-light-emission transistor between the third driving transistor and the third light-emitting diode.

The third pixel may further include a third main power line configured to provide a third main power signal, wherein the third main light-emission transistor is between the third driving transistor and the third light-emitting diode, and wherein the third pixel circuit further includes a third sub-light-emission transistor between the third driving transistor and the third main power line.

The first pixel circuit may further include a first stabilization capacitor, wherein the second pixel circuit further includes a second stabilization capacitor, and wherein the third pixel circuit further includes a third stabilization capacitor between an electrode of the third driving transistor and the third main power line.

The first pixel may further include an initialization line configured to provide a first initialization control signal, wherein the second pixel further includes a second initialization line configured to provide a second initialization signal, wherein the third pixel further includes a third initialization line configured to provide a third initialization signal, wherein the first pixel circuit further includes a first initialization transistor, wherein the second pixel circuit further includes a second initialization transistor, and wherein the third pixel circuit further includes a third initialization transistor between the third initialization line and the third light-emitting diode.

The first pixel circuit may further include a first compensation capacitor, wherein the second pixel circuit further includes a second compensation capacitor, and wherein the third pixel circuit includes a third compensation capacitor between the third output electrode and the third control electrode of the third driving transistor.

A display panel according to one or more other embodiments of the present disclosure may include a first pixel including a first pixel circuit and a first light-emitting diode, and a second pixel including a second pixel circuit and a second light-emitting diode, wherein the first pixel circuit and the second pixel circuit include a metal pattern including a first lower electrode portion, a semiconductor pattern above the metal pattern, and including a first semiconductor portion overlapping the first lower electrode portion, a second semiconductor portion extending from the first semiconductor portion, and a third semiconductor portion spaced apart from the first semiconductor portion and the second semiconductor portion, a conductive pattern above the semiconductor pattern and including a first upper electrode portion overlapping the first lower electrode portion and the first semiconductor portion, a second upper electrode portion overlapping the second semiconductor portion, and a third upper electrode portion overlapping the third semiconductor portion, the first upper electrode portion, the second upper electrode portion, and the third upper electrode portion being spaced apart from one another, and a connection electrode pattern above the conductive pattern and including a first connection electrode portion contacting the second upper electrode portion through a first contact hole, or contacting the third upper electrode portion through a second contact hole, and a second connection electrode portion contacting the first lower electrode portion through a third contact hole, wherein the first connection electrode portion of the first pixel circuit is electrically connected to the second connection electrode portion of the second pixel circuit.

The metal pattern may further include a second lower electrode portion, a third lower electrode portion, a fourth lower electrode portion, and a fifth lower electrode portion, wherein the first lower electrode portion, the second lower electrode portion, the third lower electrode portion, the fourth lower electrode portion, and the fifth lower electrode portion are spaced apart from one another, wherein the semiconductor pattern further includes a fourth semiconductor portion extending from the third semiconductor portion, a fifth semiconductor portion spaced apart from the first semiconductor portion, the second semiconductor portion, the third semiconductor portion, and the fourth semiconductor portion, a sixth semiconductor portion extending from the fifth semiconductor portion, and overlapping the first lower electrode portion and the third lower electrode portion, and a seventh semiconductor portion spaced apart from the first semiconductor portion, the second semiconductor portion, the third semiconductor portion, the fourth semiconductor portion, the fifth semiconductor portion, and the sixth semiconductor portion, and overlapping with the first lower electrode portion, wherein the conductive pattern further includes a fourth upper electrode portion overlapping the fourth semiconductor portion, a fifth upper electrode portion overlapping the fifth semiconductor portion, and a sixth upper electrode portion overlapping the sixth semiconductor portion, and wherein the fourth upper electrode portion, the fifth upper electrode portion, and the sixth upper electrode portion are spaced apart from one another.

The second connection electrode portion may contact the first semiconductor portion through a fourth contact hole, wherein the connection electrode pattern further includes a third connection electrode portion contacting a seventh upper electrode portion of the conductive pattern through a fifth contact hole, and contacting the fifth upper electrode portion through a sixth contact hole, a fourth connection electrode portion contacting the sixth semiconductor portion through a seventh contact hole, and contacting the first upper electrode portion through an eighth contact hole, a fifth connection electrode portion contacting the second semiconductor portion through a ninth contact hole, and contacting the second lower electrode portion through a tenth contact hole, a sixth connection electrode portion contacting the fourth semiconductor portion through an eleventh contact hole, and contacting the fifth lower electrode portion through a twelfth contact hole, a seventh connection electrode portion, an eighth connection electrode portion, and a ninth connection electrode portion.

An electronic device according to one or more embodiments of the present disclosure may include a display panel, the display panel including a first pixel including a first light-emitting diode, and a first pixel circuit including a first driving transistor electrically connected to the first light-emitting diode, and including a first input electrode, a first output electrode, a first control electrode, and a first sub-control electrode, and a first main light-emission transistor connected in series with the first driving transistor, and configured to be controlled by a first control signal, and a second pixel including a second light-emitting diode, and a second pixel circuit including a second driving transistor electrically connected to the second light-emitting diode, and including a second input electrode, a second output electrode, a second control electrode, and a second sub-control electrode configured to receive the first control signal, and a second main light-emission transistor connected in series with the second driving transistor.

According to one or more embodiments of the present disclosure, it is possible to provide a display panel, and an electronic device including the same, in which the low-gray-scale driving range is expanded, and in which low-gray-scale display capability is enhanced, without increasing power consumption, by applying an electrical signal to the back-gate electrode of the driving transistor, as opposed to altering the physical properties of the driving transistor.

### BRIEF DESCRIPTION OF THE DRAWINGS

These and/or other features will become apparent and more readily appreciated from the following description of the embodiments, taken in conjunction with the accompanying drawings in which:

FIGS. 1A and 1B are an assembled perspective view and an exploded perspective view, respectively, of an electronic device according to one or more embodiments of the present disclosure;

FIGS. 2A and 2B are plan views illustrating a display panel according to one or more embodiments of the present disclosure;

FIGS. 2C to 2E illustrate equivalent circuits of the first to third pixels according to one or more embodiments of the present disclosure;

FIG. 3A is a block diagram illustrating a portion of the display panel according to one or more embodiments of the present disclosure;

FIGS. 3B to 3D illustrate equivalent circuits of the first to third pixels according to one or more embodiments of the present disclosure;

FIG. 3E is a waveform diagram of signals input to the second pixel;

FIG. 3F is a waveform diagram of the first to third lower light-emission control signals;

FIG. 4A is a block diagram illustrating a portion of the display panel according to one or more embodiments of the present disclosure;

FIGS. 4B and 4C illustrate equivalent circuits of the first and second pixels according to one or more embodiments of the present disclosure;

FIG. 5A is a block diagram illustrating a portion of the display panel according to one or more embodiments of the present disclosure;

FIGS. 5B to 5D illustrate equivalent circuits of the first to third pixels according to one or more embodiments of the present disclosure;

FIGS. 6A and 6B are layout diagrams illustrating the first and second pixel circuits according to one or more embodiments of the present disclosure; and

FIGS. 7 to 12B each illustrate at least one of a plurality of patterns by way of example.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto. Additionally, the use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified.

Various embodiments are described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

Spatially relative terms, such as “beneath,” “below,” “lower,” “lower side,” “under,” “above,” “upper,” “over,” “higher,” “upper side,” “side” (e.g., as in “sidewall”), and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a plan view” means when an object portion is viewed from above. The terms “overlap” or “overlapped” mean that a first object may be above or below or to a side of a second object, and vice versa. Additionally, the term “overlap” may include stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like.

Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value. Further, the use of “may” when describing embodiments of the present disclosure refers to “one or more embodiments of the present disclosure.” Furthermore, the expression “being the same” may mean “being substantially the same”. In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

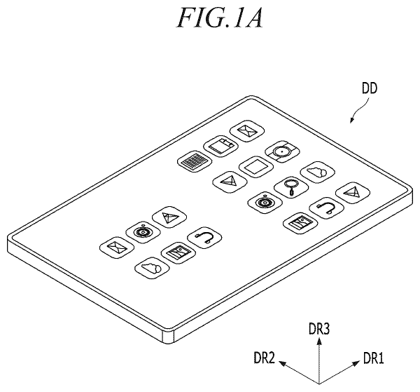

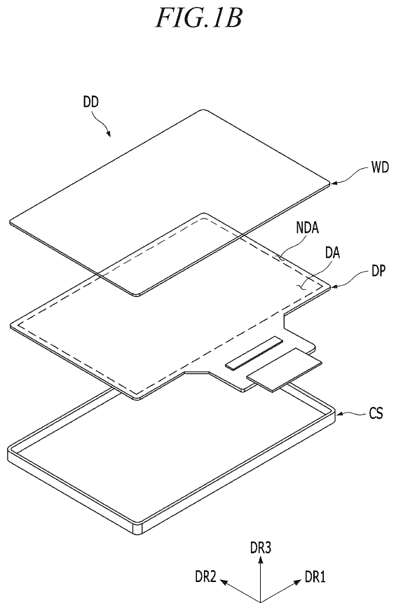

FIGS. 1A and 1B are an assembled perspective view and an exploded perspective view, respectively, of an electronic device DD according to one or more embodiments of the present disclosure. Referring to FIGS. 1A and 1B, the electronic device DD may include a window WD, a case CS, and a display panel DP. The window WD may include a transparent material, and may be configured allow light to pass through. The window WD may include an insulating material. For example, the window WD may include at least one of glass or plastic. The case CS may house the display panel DP and may be coupled to the window WD. The case CS may be configured to protect the display panel DP. The display panel DP may have a display area DA and a non-display area NDA defined therein.

The display area DA may be configured to display images. The display area DA may be parallel to a plane defined by a first direction DR1 and a second direction DR2. A third direction DR3 may be perpendicular to the display area DA. The thickness direction of the electronic device DD may correspond to the third direction DR3. The front (or top) and back (or bottom) of each member may be distinguished by the third direction DR3. However, the first through third directions are relative concepts and thus may be modified to represent other directions as necessary. In the present specification, the first through third directions may correspond to the first to third directions DR1, DR2, and DR3, as shown in FIGS. 1A and 1B. The shape of the display area DA in FIGS. 1A and 1B is illustrative, and the shape of the display area DA may be modified as required without limitation.

The non-display area NDA may be an area where images are not displayed, and may surround the display area DA (e.g., in plan view). However, the shape of the non-display area NDA in this disclosure is not limited to what is illustrated herein and may be modified as suitable without restriction.

In one or more embodiments of the present disclosure, the display panel DP may be a light-emitting display panel. For example, the display panel DP may be any one of an organic light-emitting display panel, a quantum dot light-emitting display panel, a micro-LED display panel, a liquid crystal display panel, an electrophoretic display panel, or an electrowetting display panel. A light-emitting layer of the organic light-emitting display panel may include an organic light-emitting material. An inorganic light-emitting display panel may include a quantum dot light-emitting display panel and a micro light-emitting display panel based on inorganic materials. Hereinafter, the display panel DP will be described with reference to an organic light-emitting display panel.

Although the electronic device DD is illustrated as a tablet in FIGS. 1A and 1B, the electronic device DD of the present disclosure is not limited to what is illustrated herein. In other embodiments of the present disclosure, the electronic device DD may include a large display device and a medium- to small-sized display device. For example, the large display device may include televisions, monitors, and electronic billboards. Moreover, the medium- to small-sized display device may include tablets, built-in displays in home appliances, smartwatches, and smartphones.

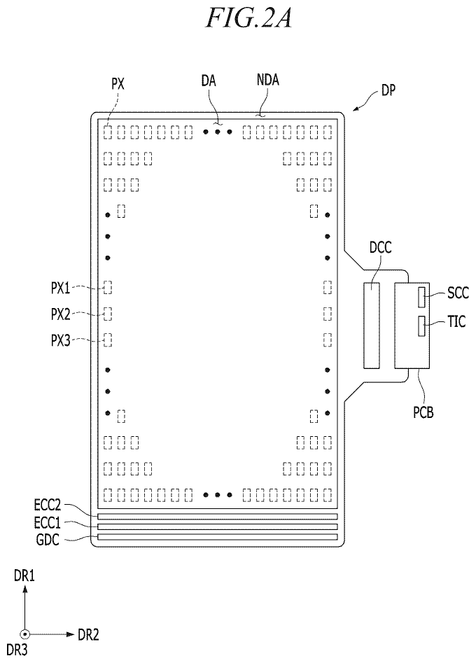

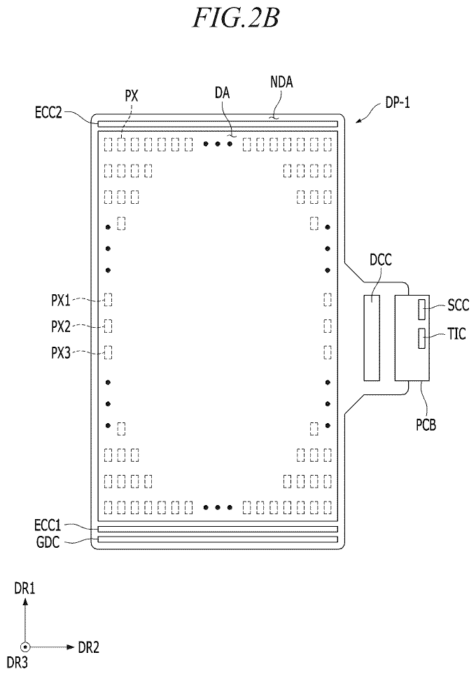

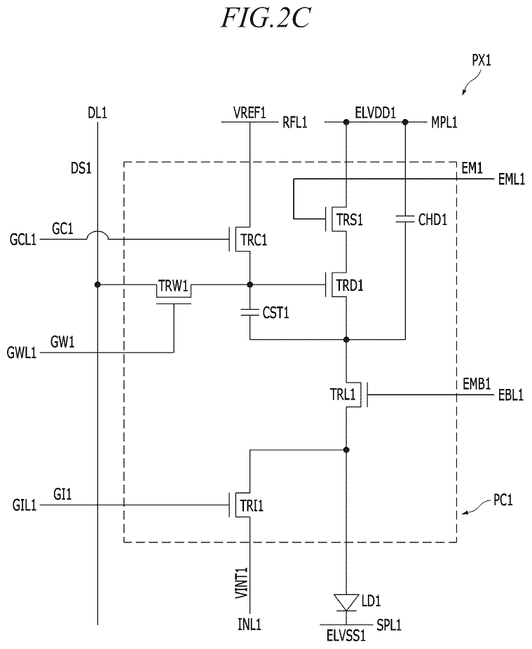

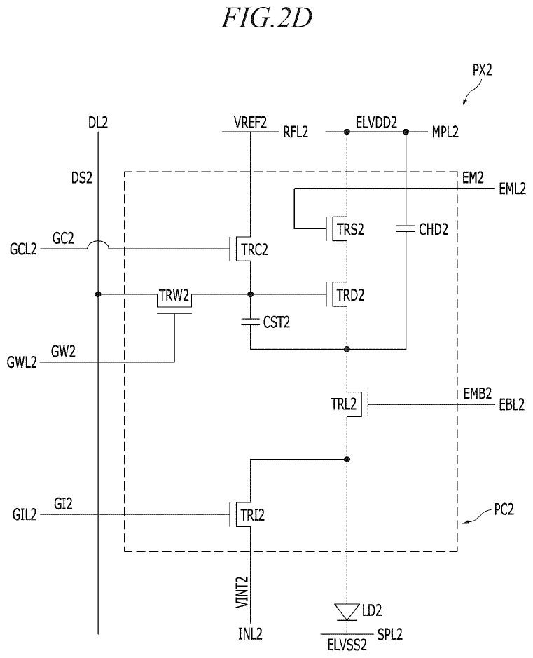

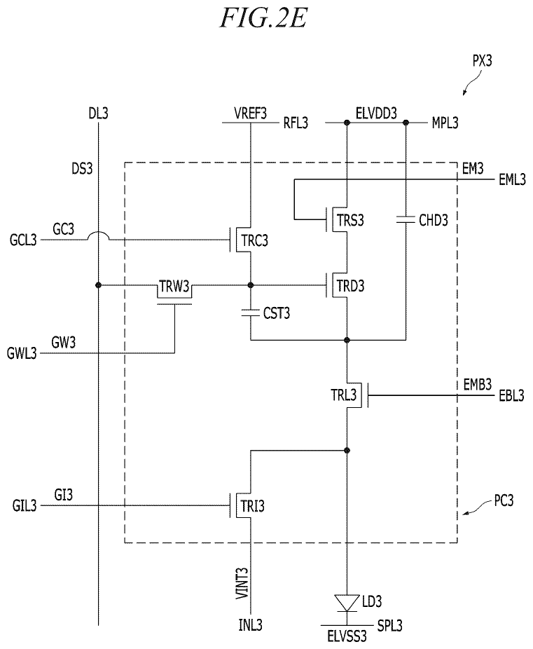

FIGS. 2A and 2B are plan views illustrating a display panel DP, DP-1 according to one or more embodiments of the present disclosure. FIGS. 2C to 2E illustrate equivalent circuits of the first to third pixels PX1, PX2, and PX3 according to one or more embodiments of the present disclosure.

Referring to FIGS. 2A through 2E, the display panel DP may include a pixel PX, a signal control circuit SCC, a gate-driving circuit GDC, a first light-emission control circuit ECC1, a second light-emission control circuit ECC2, a data-driving circuit DCC, a circuit board PCB, and an input-sensing-driving circuit TIC.

The pixel PX may be provided in plurality. A first pixel PX1 may represent the i-th pixel among the plurality of pixels, a second pixel PX2 may represent the (i+1)-th pixel among the plurality of pixels, and the third pixel PX3 may represent the (i+2)-th pixel among the plurality of pixels.

The signal control circuit SCC may be configured to control at least one of the input-sensing-driving circuit TIC, the gate-driving circuit GDC, the data-driving circuit DCC, the first light-emission control circuit ECC1, or the second light-emission control circuit ECC2. The signal control circuit SCC may be configured to receive image data and control signals from an external graphics controller, in one or more embodiments. The control signals may include a vertical synchronization signal, a horizontal synchronization signal, a data enable signal, and a clock signal. The vertical synchronization signal may be a signal that distinguishes frame intervals, and the horizontal synchronization signal may be a signal that distinguishes horizontal intervals (i.e., row distinction signal).

In one or more embodiments of the present disclosure, the signal control circuit SCC may be a timing controller. However, the signal control circuit SCC of the present disclosure is not limited thereto, as long as it is configured to control at least one of the input-sensing-driving circuit TIC, the gate-driving circuit GDC, the data-driving circuit DCC, the first light-emission control circuit ECC1, or the second light-emission control circuit ECC2.

The gate-driving circuit GDC may be configured to receive a control signal from the signal control circuit SCC and to provide a write control signal GW, a compensation control signal GC, and an initialization control signal GI to the pixels PX.

In one or more embodiments of the present disclosure, the gate-driving circuit GDC may be formed simultaneously with the pixels PX through a thin-film process. For example, the gate-driving circuit GDC may be installed in the form of an OSG (Oxide Semiconductor TFT Gate driver circuit) or an ASG (Amorphous Silicon TFT Gate driver circuit).

The first light-emission control circuit ECC1 may be configured to receive a control signal from the signal control circuit SCC and to provide an upper light-emission control signal EM to the pixels PX. The second light-emission control circuit ECC2 may be configured to receive a control signal from the signal control circuit SCC and to provide a lower light-emission control signal EMB to the pixels PX.

Referring to FIG. 2A, in one or more embodiments of the present disclosure, the first light-emission control circuit ECC1 and the second light-emission control circuit ECC2 may be positioned on one side of the display area DA. That is, the first light-emission control circuit ECC1 and the second light-emission control circuit ECC2 may be arranged adjacent to each other.

Referring to FIG. 2B, in one or more other embodiments of the present disclosure, one of the first light-emission control circuit ECC1 or the second light-emission control circuit ECC2 may be positioned on one side of the display area DA, and the other of the first light-emission control circuit ECC1 or the second light-emission control circuit ECC2 may be positioned on the opposite side of the display area DA. In other words, the first light-emission control circuit ECC1 and the second light-emission control circuit ECC2 may be arranged to face each other across the display area DA.

The arrangements of the first light-emission control circuit ECC1 and the second light-emission control circuit ECC2 in FIGS. 2A and 2B are illustrative examples only, and the placement of the first light-emission control circuit ECC1 and the second light-emission control circuit ECC2 is not limited to what is illustrated herein. In other embodiments of the present disclosure, the arrangements of the first light-emission control circuit ECC1 and the second light-emission control circuit ECC2 may be modified as needed without restriction.

The data-driving circuit DDC may be configured to receive a control signal from the signal control circuit SCC, and to provide a data signal DS to the pixels PX.

The input-sensing-driving circuit TIC and the signal control circuit SCC may be mounted on the circuit board PCB. The input-sensing-driving circuit TIC may be configured to process signals corresponding to a user's touch and signals corresponding to external pressure. For example, the circuit board PCB may be a flexible printed circuit board.

Although the gate-driving circuit GDC, the first light-emission control circuit ECC1, and the second light-emission control circuit ECC2 are depicted as separate components in FIGS. 2A and 2B, the gate-driving circuit GDC, the first light-emission control circuit ECC1, and the second light-emission control circuit ECC2 of the present disclosure are not limited to what is depicted herein. In other embodiments of the present disclosure, some of the gate-driving circuit GDC, the first light-emission control circuit ECC1, and the second light-emission control circuit ECC2 may be provided as a single component.

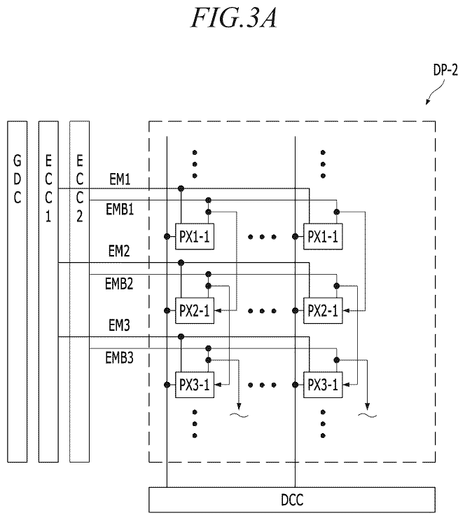

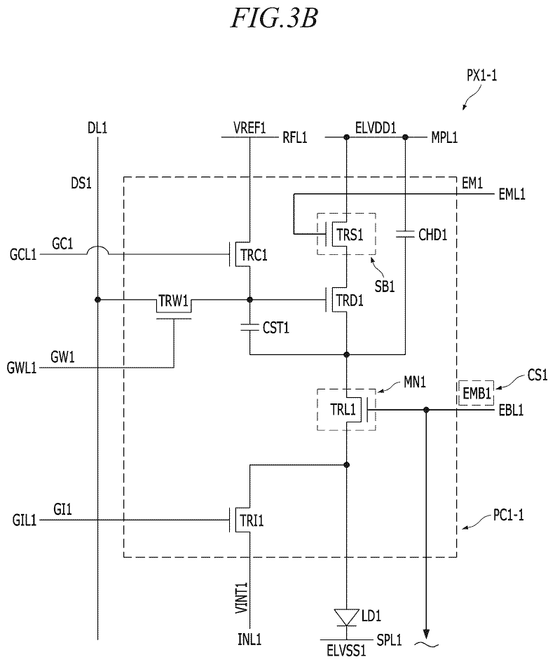

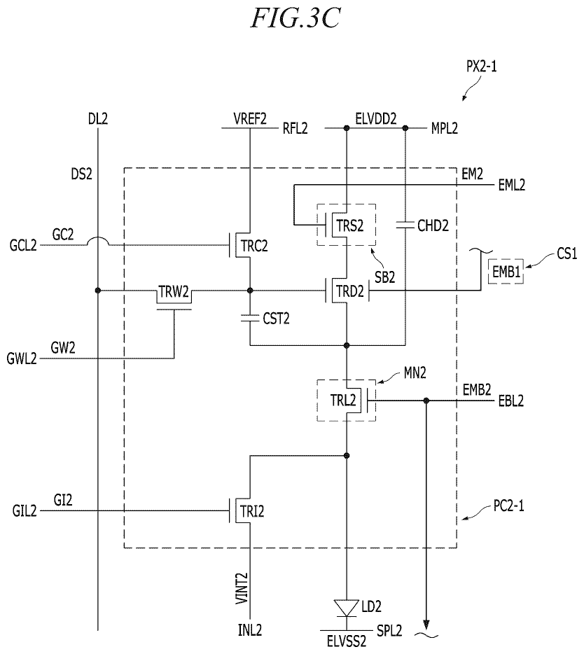

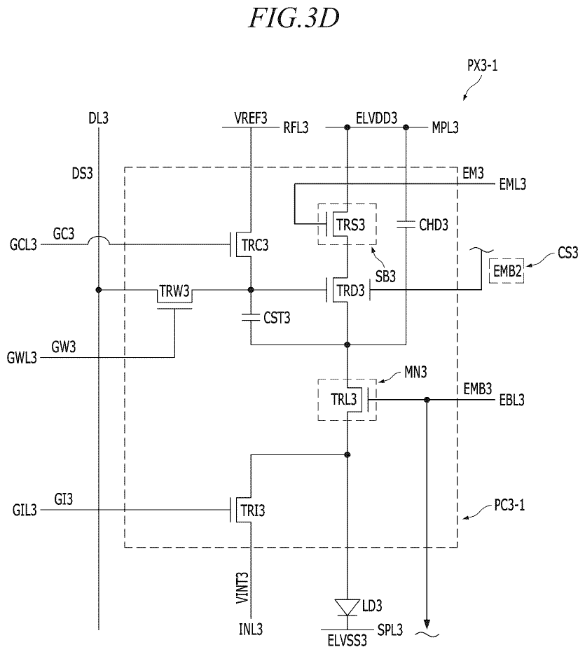

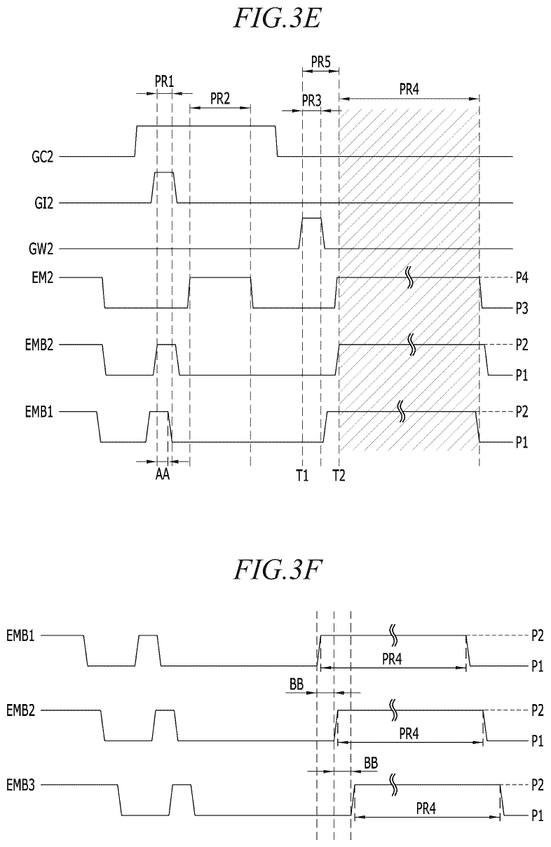

A feature of the present disclosure is that a signal controlling the light emission of one of the plurality of pixels is configured to modify the driving range of a driving transistor associated with another pixel. FIGS. 2C through 2E describe general technical content related to the first to third pixels PX1-PX3, excluding the aforementioned feature, while FIGS. 3A through 5D describe embodiments in detail that implement the aforementioned feature.

Referring to FIG. 2C, the first pixel PX1 in accordance with one or more embodiments of the present disclosure may include a first main power line MPL1, a first sub-power line SPL1, a first data line DL1, a first scan line GWL1, a first compensation control line GCL1, a first initialization control line GIL1, a first reference voltage line RFL1, a first upper light-emission control line EML1, a first lower light-emission control line EBL1, a first initialization line INL1, a first pixel circuit PC1, and a first light-emitting diode LD1.

In one or more embodiments of the present disclosure, the second pixel PX2 may be arranged between the first pixel PX1 and the third pixel PX3. In one or more other embodiments of the present disclosure, the first pixel PX1 may be arranged adjacent to the second pixel PX2, and the second pixel PX2 may be arranged adjacent to the third pixel PX3. However, the arrangement of the first pixel PX1, second pixel PX2, and third pixel PX3 is not limited to what is described herein, as long as each of the first pixel PX1, second pixel PX2, and third pixel PX3 represents any one of the plurality of pixels.

The first main power line MPL1 may be configured to provide a first main power signal ELVDD1. The first sub-power line SPL1 may be configured to provide a first sub-power signal ELVSS1. The first data line DL1 may be configured to provide a first data signal DS1. The first scan line GWL1 may be configured to provide a first write control signal GW1. The first compensation control line GCL1 may be configured to provide a first compensation control signal GC1. The first initialization control line GIL1 may be configured to provide a first initialization control signal GI1. The first reference voltage line RFL1 may be configured to provide a first reference voltage signal VREF1. The first upper light-emission control line EML1 may be configured to provide a first upper light-emission control signal EM1. The first lower light-emission control line EBL1 may be configured to provide a first lower light-emission control signal EMB1. The first initialization line INL1 may be configured to provide a first initialization signal VINT1.

In one or more embodiments of the present disclosure, at least one of the first main power line MPL1, first sub-power line SPL1, first data line DL1, first scan line GWL1, first compensation control line GCL1, first initialization control line GIL1, first reference voltage line RFL1, first upper light-emission control line EML1, first lower light-emission control line EBL1, or first initialization line INL1 may be omitted.

The first pixel circuit PC1 may be configured to control a current flowing through the first light-emitting diode LD1 in response to the first data signal DS1. The first pixel circuit PC1 may include a first driving transistor TRD1, a first switching transistor TRW1, a first compensation transistor TRC1, a first initialization transistor TRI1, a first upper light-emission transistor TRS1, a first lower light-emission transistor TRL1, a first compensation capacitor CST1, and a first stabilization capacitor CHD1. In one or more embodiments of the present disclosure, at least one of the first switching transistor TRW1, first compensation transistor TRC1, first initialization transistor TRI1, first upper light-emission transistor TRS1, first lower light-emission transistor TRL1, first compensation capacitor CST1, or first stabilization capacitor CHD1 may be omitted.

In this specification, either the first upper light-emission transistor TRS1 or the first lower light-emission transistor TRL1 may be referred to as a first main light-emission transistor, and the other may be referred to as a first sub-light-emission transistor.

In one or more embodiments of the present disclosure, each of the first driving transistor TRD1, first switching transistor TRW1, first compensation transistor TRC1, first initialization transistor TRI1, first upper light-emission transistor TRS1, and first lower light-emission transistor TRL1 may be configured as an oxide thin-film transistor. In one or more other embodiments of the present disclosure, each of the first driving transistor TRD1, first switching transistor TRW1, first compensation transistor TRC1, first initialization transistor TRI1, first upper light-emission transistor TRS1, and first lower light-emission transistor TRL1 may be configured as a low-temperature polycrystalline silicon (LTPS) thin-film transistor. However, the present disclosure is not limited to what is described herein, and the first pixel PX1 of the present disclosure may be configured with various combinations of at least one oxide thin-film transistor or LTPS thin-film transistor.

In one or more embodiments of the present disclosure, the first driving transistor TRD1, the first switching transistor TRW1, the first compensation transistor TRC1, the first initialization transistor TRI1, the first upper light-emission transistor TRS1, and the first lower light-emission transistor TRL1 may each be an nMOS (n-channel MOSFET). In one or more other embodiments of the present disclosure, the first driving transistor TRD1, the first switching transistor TRW1, the first compensation transistor TRC1, the first initialization transistor TRI1, the first upper light-emission transistor TRS1, and the first lower light-emission transistor TRL1 may each be a pMOS (p-channel MOSFET). However, the first pixel PX1 of the present disclosure is not limited to what is described herein, and may be configured with various combinations of at least one nMOS and/or pMOS.

In the present specification, the input electrode refers to one of a source electrode or a drain electrode, and the output electrode refers to the other of the source electrode or the drain electrode. Meanwhile, the control electrode refers to the gate electrode, and the sub-control electrode refers to the back-gate electrode.

The first driving transistor TRD1 may be electrically connected to the first light-emitting diode LD1. The first driving transistor TRD1 may include a first input electrode, a first output electrode, a first control electrode, and a first sub-control electrode. The current flowing through the first light-emitting diode LD1 may be controlled according to the voltage of the first control electrode of the first driving transistor TRD1.

The first switching transistor TRW1 may be configured to be controlled by the first write control signal GW1. The first switching transistor TRW1 may be arranged between the first data line DL1 and the first control electrode of the first driving transistor TRD1. The first switching transistor TRW1 may be configured to be turned on by the first write control signal GW1 to transfer at least a portion of the first data signal DS1 to the first control electrode of the first driving transistor TRD1.

The first initialization transistor TRI1 may be arranged between the first initialization line INL1 and the first driving transistor TRD1. The first initialization transistor TRI1 may be configured to be controlled by the first initialization control signal GI1. The first initialization transistor TRI1 may be configured to be turned on by the first initialization control signal GI1 to transfer at least a portion of the first initialization signal VINT1 to the anode electrode of the first light-emitting diode LD1.

The first upper light-emission transistor TRS1 may be arranged between the first driving transistor TRD1 and the first main power line MPL1. The first upper light-emission transistor TRS1 may include an input electrode, a control electrode, and an output electrode. The first upper light-emission transistor TRS1 may be configured to be turned on by the first upper light-emission control signal EM1 to transfer at least a portion of the first main power signal ELVDD1 to the input electrode of the first driving transistor TRD1.

The first lower light-emission transistor TRL1 may be arranged between the first driving transistor TRD1 and the first light-emitting diode LD1. The first lower light-emission transistor TRL1 may include an input electrode, a control electrode, and an output electrode. The first lower light-emission transistor TRL1 may be configured to be turned on by the first lower light-emission control signal EMB1 to electrically connect the first output electrode of the first driving transistor TRD1 to the first light-emitting diode LD1.

The first compensation capacitor CST1 may be arranged between the first control electrode of the first driving transistor TRD1 and the first output electrode of the first driving transistor TRD1. The first compensation capacitor CST1 may be configured to store a charge corresponding to the potential difference between the first output electrode of the first driving transistor TRD1 and the first control electrode of the first driving transistor TRD1.

The first compensation transistor TRC1 may be arranged between the first reference voltage line RFL1 and the first compensation capacitor CST1. The first compensation transistor TRC1 may be configured to be controlled by the first compensation control signal GC1. The first compensation transistor TRC1 may be configured to be turned on by the first compensation control signal GC1 to transfer at least a portion of the first reference voltage signal VREF1 to the first control electrode of the first driving transistor TRD1.

The first stabilization capacitor CHD1 may be arranged between the first driving transistor TRD1 and the first main power line MPL1. The first stabilization capacitor CHD1 may be configured to store a charge corresponding to the potential difference between the first output electrode of the first driving transistor TRD1 and the first main power line MPL1.

The first light-emitting diode LD1 may be configured to emit light at a corresponding (e.g., predetermined) brightness in response to the current supplied by the first pixel circuit PC1. To this end, the voltage value of the first main power signal ELVDD1 may be higher than that of the first sub-power signal ELVSS1. The anode electrode of the first light-emitting diode LD1 may be electrically connected to the first output electrode of the first lower light-emission transistor TRL1. The first sub-power signal ELVSS1 may be provided to the cathode electrode of the first light-emitting diode LD1. In one or more embodiments of the present disclosure, the first light-emitting diode LD1 may be an organic light-emitting diode (OLED). However, the first light-emitting diode LD1 of the present disclosure is not limited thereto, as long as the first light-emitting diode LD1 is an element emitting light in response to a current being input.

Referring to FIG. 2D, the second pixel PX2 in accordance with one or more embodiments of the present disclosure may include a second main power line MPL2, a second sub-power line SPL2, a second data line DL2, a second scan line GWL2, a second compensation control line GCL2, a second initialization control line GIL2, a second reference voltage line RFL2, a second upper light-emission control line EML2, a second lower light-emission control line EBL2, a second initialization line INL2, a second pixel circuit PC2, and a second light-emitting diode LD2.

The second pixel circuit PC2 may include a second driving transistor TRD2, a second switching transistor TRW2, a second compensation transistor TRC2, a second initialization transistor TRI2, a second upper light-emission transistor TRS2, a second lower light-emission transistor TRL2, a second compensation capacitor CST2, and a second stabilization capacitor CHD2. In the present specification, one of the second upper light-emission transistor TRS2 or the second lower light-emission transistor TRL2 may be referred to as the second main light-emission transistor, and the other of the second upper light-emission transistor TRS2 or the second lower light-emission transistor TRL2 may be referred to as the second sub-light-emission transistor.

The second driving transistor TRD2 may include a second input electrode, a second output electrode, a second control electrode, and a second sub-control electrode.

Further description of the components of the second pixel PX2 is substantially identical to that provided with reference to FIG. 2C and thus is omitted.

Referring to FIG. 2E, the third pixel PX3 in accordance with one or more embodiments of the present disclosure may include a third main power line MPL3, a third sub-power line SPL3, a third data line DL3, a third scan line GWL3, a third compensation control line GCL3, a third initialization control line GIL3, a third reference voltage line RFL3, a third upper light-emission control line EML3, a third lower light-emission control line EBL3, a third initialization line INL3, a third pixel circuit PC3, and a third light-emitting diode LD3.

Although it is depicted in FIGS. 2C to 2F that the first to third data lines DL1, DL2, and/or DL3 are as separate wirings distinguishable from each other, they are depicted as such for the convenience of description, and the first to third data lines DL1, DL2, and/or DL3 of the present disclosure are not limited to what is illustrated herein. In one or more embodiments of the present disclosure, the first to third data lines DL1, DL2, and/or DL3 may be provided as a single wiring.

The third pixel circuit PC3 may include a third driving transistor TRD3, a third switching transistor TRW3, a third compensation transistor TRC3, a third initialization transistor TRI3, a third upper light-emission transistor TRS3, a third lower light-emission transistor TRL3, a third compensation capacitor CST3, and a third stabilization capacitor CHD3. In the present specification, one of the third upper light-emission transistor TRS3 or the third lower light-emission transistor TRL3 may be referred to as the third main light-emission transistor, and the other of the third upper light-emission transistor TRS3 or the third lower light-emission transistor TRL3 may be referred to as the third sub-light-emission transistor.

The third driving transistor TRD3 may include a third input electrode, a third output electrode, a third control electrode, and a third sub-control electrode.

Further description of the components of the third pixel PX3 is substantially identical to that provided with reference to FIG. 2C and thus is omitted.

FIG. 3A is a block diagram illustrating a portion of the display panel DP-2 according to one or more embodiments of the present disclosure. FIGS. 3B to 3D illustrate equivalent circuits of the first to third pixels PX1-1, PX2-1, and/or PX3-1 according to one or more embodiments of the present disclosure.

Referring to FIGS. 3A to 3D, in one or more embodiments of the present disclosure, the first main light-emission transistor MN1 may be arranged between the first driving transistor TRD1 and the first light-emitting diode LD1. That is, the first main light-emission transistor MN1 may be the first lower light-emission transistor TRL1.

In one or more embodiments of the present disclosure, the first control signal CS1 may be the first lower light-emission control signal EMB1. The first control signal CS1 may be provided to the second sub-control electrode of the second driving transistor TRD2 to allow the driving range of the second driving transistor TRD2 to be modified. Accordingly, the driving range of the second driving transistor TRD2 may be expanded, thereby improving the low-gray-level display capability of the display panel DP.

In one or more embodiments of the present disclosure, the first sub-light-emission transistor SB1 may be arranged between the first driving transistor TRD1 and the first main power line MPL1. The first sub-light-emission transistor SB1 may be the first upper light-emission transistor TRS1.

In one or more embodiments of the present disclosure, the second main light-emission transistor MN2 may be arranged between the second driving transistor TRD2 and the second light-emitting diode LD2, and the second sub-light-emission transistor SB2 may be arranged between the second driving transistor TRD2 and the second main power line MPL2. That is, the second main light-emission transistor MN2 may be the second lower light-emission transistor TRL2, and the second sub-light-emission transistor SB2 may be the second upper light-emission transistor TRS2.

Further description of the components of the first to third pixels PX1-1, PX2-1, and/or PX3-1 is substantially identical to that provided with reference to FIGS. 2C to 2E, and thus is omitted.

FIG. 3E is a waveform diagram of the signals input to the second pixel PX2. Hereinafter, the operation of the second pixel PX2 will be described with reference to FIG. 3E.

During a first period PR1, the second compensation transistor TRC2 and the second initialization transistor TRI2 may turn on together. Accordingly, at least a portion of the second reference voltage signal VREF2 may be transferred to the second control electrode of the second driving transistor TRD2, and at least a portion of the second initialization control signal VINT2 may be provided to the anode electrode of the second light-emitting diode LD2.

In one or more embodiments of the present disclosure, a corresponding (e.g., predetermined) period AA may be part of the first period PR1, and the first lower light-emission control signal EMB1 may be provided to the second sub-control electrode of the second driving transistor TRD2 during the corresponding period AA. That is, during the corresponding period AA, the driving range of the second driving transistor TRD2 may be modified by the first lower light-emission control signal EMB1. Accordingly, the driving range of the second driving transistor TRD2 may be expanded, thereby improving the low-gray-level display capability of the display panel DP-2.

During a second period PR2, the second compensation transistor TRC2 and the second upper light-emission transistor TRS2 may turn on together. Once the second compensation transistor TRC2 turns on, at least a portion of the second reference voltage signal VREF2 may be transferred to the second control electrode of the second driving transistor TRD2 to allow the second driving transistor TRD2 to turn on. Accordingly, at least a portion of the second main power signal ELVDD2 may be transferred to the second output electrode of the second driving transistor TRD2 via the second upper light-emission transistor TRS2.

During a third period PR3, the second switching transistor TRW2 may turn on to allow at least a portion of the second data signal DS2 to be transferred to the second control electrode of the second driving transistor TRD2. Accordingly, the second driving transistor TRD2 may turn on.

During a fourth period PR4, the second upper light-emission transistor TRS2 and the second lower light-emission transistor TRL2 may turn on together. During the fourth period PR4, the light-emitting diode LD2 may emit light.

A fifth period PR5 may be a period from a first time T1 to a second time T2. The first time T1 may be the moment when the second switching transistor TRW2 turns on during the third period PR3, and the second time T2 may be the moment when the second lower light-emission transistor TRL2 turns on during the fourth period PR4.

During the fifth period PR5, the potential of the first lower light-emission control signal EMB1 may change from a first value P1 to a second value P2. Because the first lower light-emission control signal EMB1 is transferred to the second driving transistor TRD2, the driving range of the second driving transistor TRD2 may be modified by the first lower light-emission control signal EMB1. That is, the driving range of the second driving transistor TRD2 may be modified before the second light-emitting diode LD2 emits light. Accordingly, the driving range of the second driving transistor TRD2 may be expanded, thereby improving the low-gray-level display capability of the display panel DP-2.

FIG. 3F is a waveform diagram of the first to third lower light-emission control signals EMB1, EMB2, and EMB3.

Referring to FIG. 3F, the potential of the first to third lower light-emission control signals EMB1, EMB2, and EMB3 may sequentially change with an interval of a corresponding (e.g., predetermined) time BB. Accordingly, the driving range of the second driving transistor TRD2 may be modified by the first lower light-emission control signal EMB1 during the corresponding time BB before the second light-emitting diode LD2 emits light, and the driving range of the third driving transistor TRD3 may be modified by the second lower light-emission control signal EMB2 during the corresponding time BB before the third light-emitting diode LD3 emits light. Accordingly, the driving range of the second driving transistor TRD2 may be expanded, thereby improving the low-gray-level display capability of the display panel DP-2.

Accordingly, once the potential of the first lower light-emission control signal EMB1 changes from the first value P1 to the second value P2 and the corresponding time BB has elapsed, the potential of the second lower light-emission control signal EMB2 may change from the first value P1 to the second value P2. Further, once the potential of the second lower light-emission control signal EMB2 changes from the first value P1 to the second value P2 and another corresponding (e.g., predetermined) time BB has elapsed, the potential of the third lower light-emission control signal EMB3 may change from the first value P1 to the second value P2.

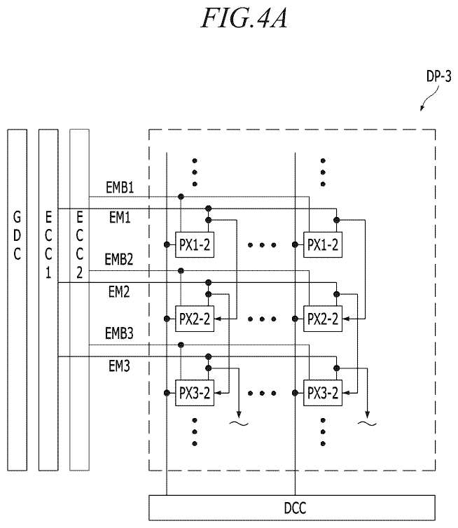

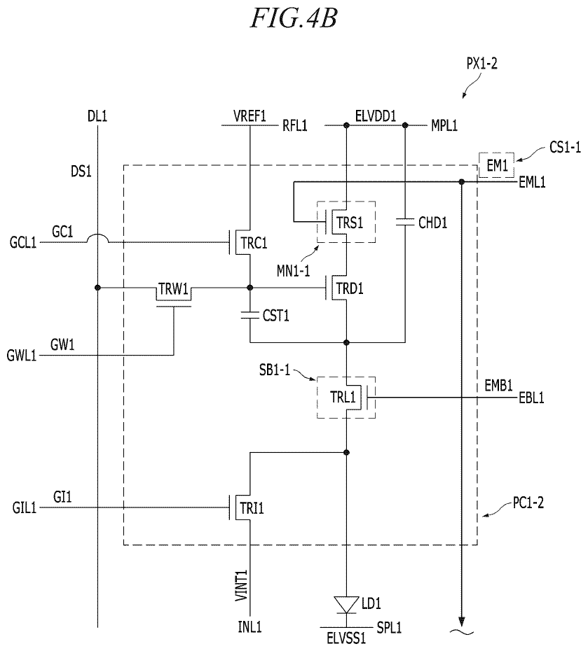

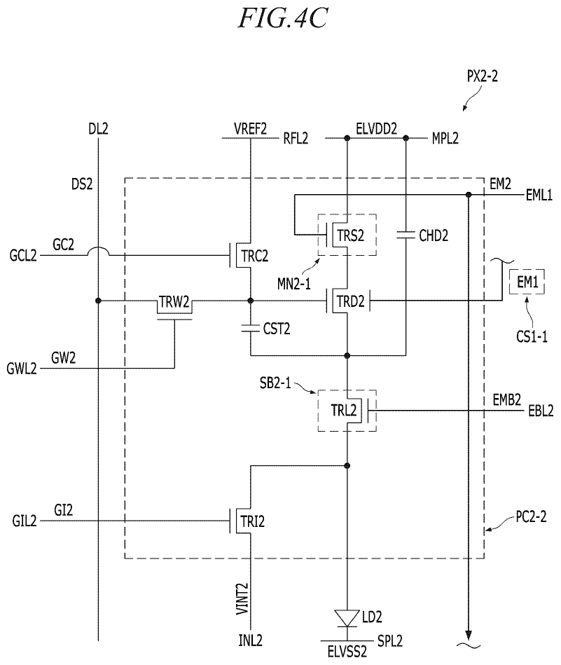

FIG. 4A is a block diagram illustrating a portion of the display panel DP-3 according to one or more embodiments of the present disclosure. FIGS. 4B and 4C illustrate equivalent circuits of the first pixel PX1-1 and the second pixel PX2-2 according to one or more embodiments of the present disclosure.

Referring to FIGS. 4A to 4C, in one or more embodiments of the present disclosure, the first main light-emission transistor MN1-1 may be arranged between the first driving transistor TRD1 and the first main power line MPL1. That is, the first main light-emission transistor MN1-1 may be the first upper light-emission transistor TRS1.

In one or more embodiments of the present disclosure, the first control signal CS1-1 may be the first upper light-emission control signal EM1. The first control signal CS1-1 may be provided to the second sub-control electrode of the second driving transistor TRD2 to allow the driving range of the second driving transistor TRD2 to be modified. As a result, the driving range of the second driving transistor TRD2 may be expanded, thereby improving the low-gray-level display capability of the display panel DP-3.

In one or more embodiments of the present disclosure, the first sub-light-emission transistor SB1-1 may be arranged between the first driving transistor TRD1 and the first light-emitting diode LD1. That is, the first sub-light-emission transistor SB1-1 may be the first lower light-emission transistor TRL1.

In one or more embodiments of the present disclosure, the second main light-emission transistor MN2 may be arranged between the second driving transistor TRD2 and the second main power line MPL2, and the second sub-light-emission transistor SB2 may be arranged between the second driving transistor TRD2 and the second light-emitting diode LD2. That is, the second main light-emission transistor MN2 may be the second upper light-emission transistor TRS2, and the second sub-light-emission transistor SB2 may be the second lower light-emission transistor TRL2.

Further description of the components of the first pixel PX1-2 and the second pixel PX2-2 is substantially identical to that provided with reference to FIGS. 2C and 2D and thus is omitted.

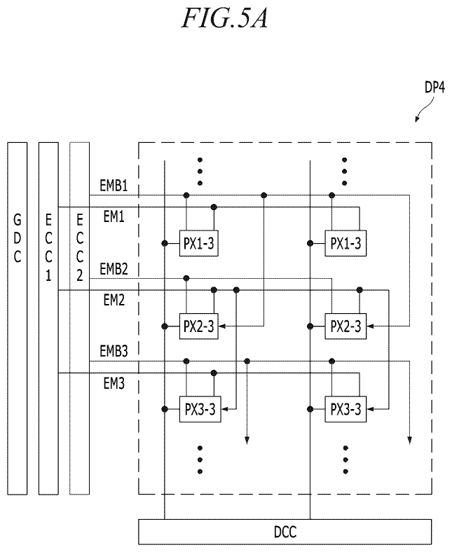

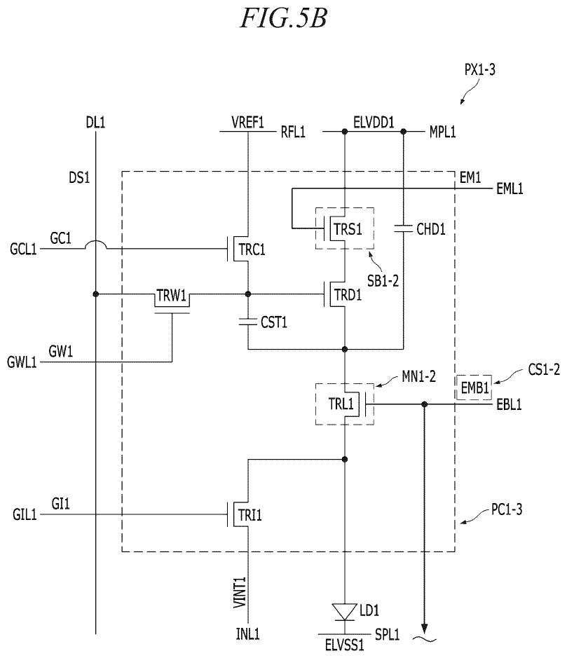

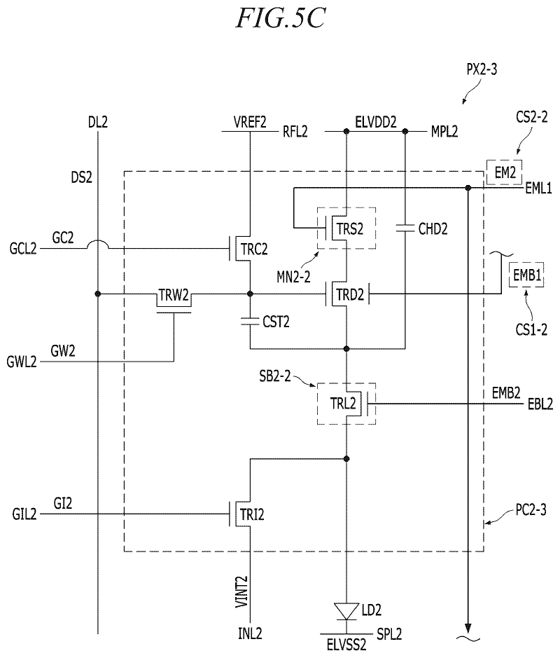

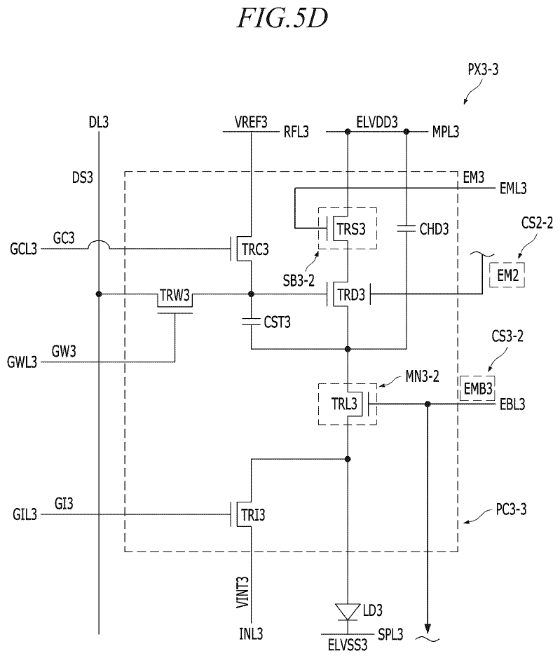

FIG. 5A is a block diagram illustrating a portion of the display panel DP-4 according to one or more embodiments of the present disclosure. FIGS. 5B to 5D illustrate equivalent circuits of the first to third pixels PX1-3 to PX3-3 according to one or more embodiments of the present disclosure.

Referring to FIGS. 5A to 5D, in one or more embodiments of the present disclosure, the first main light-emission transistor MN1-2 may be arranged between the first driving transistor TRD1 and the first light-emitting diode LD1, and the second main light-emission transistor MN2-2 may be arranged between the second driving transistor TRD2 and the second main power line MPL2. That is, the first main light-emission transistor MN1-2 may be the first lower light-emission transistor TRL1, and the second main light-emission transistor MN2-2 may be the second upper light-emission transistor TRS2.

In one or more embodiments of the present disclosure, the potential of the second control signal CS2-2 may change from a third value P3 to a fourth value P4 between the time when the third switching transistor TRW3 turns on and the time when the third main light-emission transistor MN3 turns on. In one or more embodiments of the present disclosure, the third value P3 and the fourth value P4 may be the same as the first value P1 and the second value P2, respectively. In one or more other embodiments of the present disclosure, the third value P3 and the fourth value P4 may differ from the first value P1 and the second value P2, respectively. However, the first to fourth values P1 to P4 are not limited to these values and may be modified as necessary.

In one or more embodiments of the present disclosure, the first control signal CS1-2 may be the first lower light-emission control signal EMB1. The first control signal CS1-2 may be provided to the second sub-control electrode of the second driving transistor TRD2 to allow the driving range of the second driving transistor TRD2 to be modified. As a result, the driving range of the second driving transistor TRD2 may be expanded, thereby improving the low-gray-level display capability of the display panel DP-3.

In one or more embodiments of the present disclosure, the second control signal CS2-2 may be the second upper light-emission control signal EM2. The second control signal CS2-2 may be provided to the third sub-control electrode of the third driving transistor TRD3 to allow the driving range of the third driving transistor TRD3 to be modified. Accordingly, the driving range of the third driving transistor TRD3 may be expanded, thereby enhancing the low-gray-level display capability of the display panel DP-3.

In one or more embodiments of the present disclosure, the third main light-emission transistor may be arranged between the third driving transistor TRD3 and the third light-emitting diode LD3, and the third sub-light-emission transistor may be arranged between the third driving transistor TRD3 and the third main power line MPL3.

Further description of the components of the first to third pixels PX1-3 to PX3-3 is substantially identical to that provided with reference to FIGS. 2C to 2E, and thus is omitted.

According to one or more embodiments of the present disclosure, the display panel DP may include the first pixel PX1 and the second pixel PX2. The first pixel PX1 may include the first pixel circuit PC1-4 and the first light-emitting diode LD1. The second pixel PX2-4 may include the second pixel circuit PC2-4 and the second light-emitting diode LD2.

The first pixel circuit PC1-4 and the second pixel circuit PC2-4 may each include a plurality of patterns overlapping with each other. The layout of each of the first pixel circuit PC1-4 and the second pixel circuit PC2-4 may illustrate a configuration in which the plurality of patterns are superimposed.

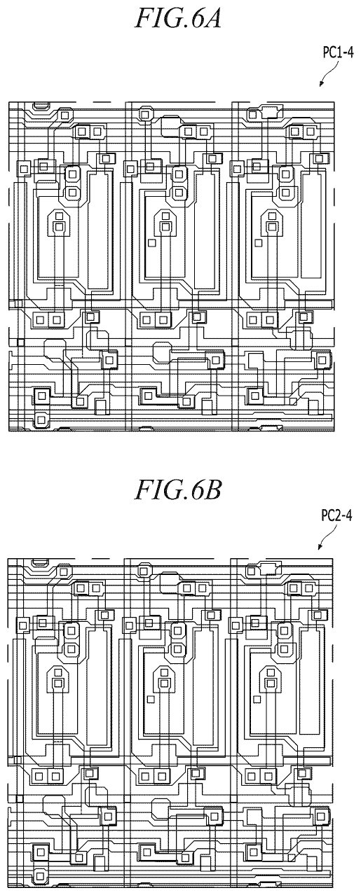

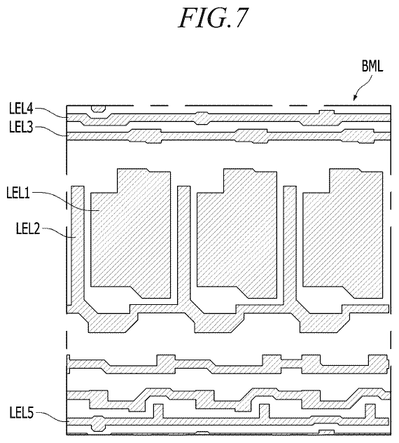

FIGS. 6A and 6B are layout diagrams illustrating the first pixel circuit PC1-4 and the second pixel circuit PC2-4 according to one or more embodiments of the present disclosure. FIGS. 7 to 12B each illustrate at least one of a plurality of patterns by way of example.

Referring to FIGS. 6A to 12B, the first pixel circuit PC1-4 and the second pixel circuit PC2-4 may each include a metal pattern BML, a semiconductor pattern OACT, a conductive pattern GAT, a contact pattern CNT, and a connection electrode pattern DAT. Because the second pixel circuit PC2-4 is substantially identical to the first pixel circuit PC1-4, the description below will focus on each of the plurality patterns with reference to the first pixel circuit PC1-4.

FIG. 7 is a plan view of the metal pattern BML. Referring to FIG. 7, the metal pattern BML may include first through fifth lower electrode portions LEL1 through LEL5. The first through fifth lower electrode portions LEL1 through LEL5 may be spaced apart from one another.

The second lower electrode portion LEL2 may be configured to provide the first main power signal ELVDD1. The third lower electrode portion LEL3 may be configured to provide the first reference voltage signal VREF1. The fourth lower electrode portion LEL4 may be configured to provide the first data signal DS1. The fifth lower electrode portion LEL5 may be configured to provide the first initialization signal VINT1.

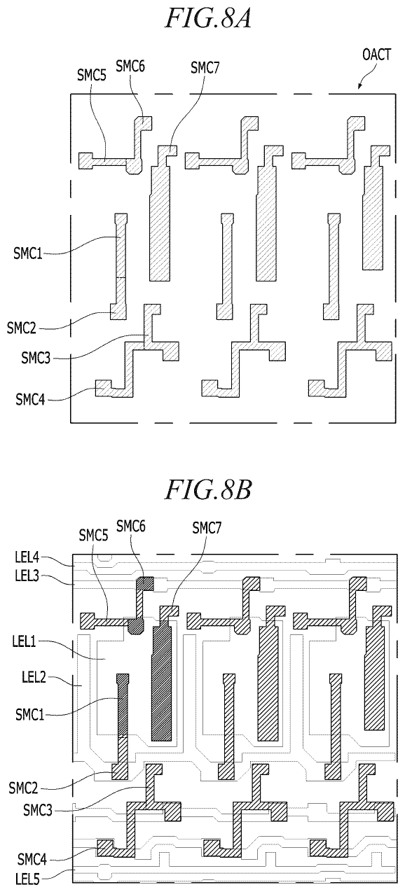

FIG. 8A is a plan view of the semiconductor pattern OACT, and FIG. 8B illustrates a shape in which FIG. 8A is superimposed onto FIG. 7. In FIG. 8B, the portions corresponding to FIG. 8A are shown with a darker shade compared to the portions corresponding to FIG. 7, although this is merely for the convenience of description, and the form and color of the metal pattern BML are not limited thereto.

Referring to FIGS. 8A and 8B, the semiconductor pattern OACT may include first through seventh semiconductor portions SMC1, SMC2, SMC3, SMC4, SMC5, SMC6, and SMC7. The semiconductor pattern OACT may be arranged on the metal pattern BML.

Each of the first through seventh semiconductor portions SMC1 through SMC7 may overlap or electrically connect with at least some of the underlying patterns. Examples are provided below, but these examples are merely illustrative, and the relationships between the semiconductor pattern OACT and other patterns are not limited to these examples.

The first semiconductor portion SMC1 may overlap with the first lower electrode portion LEL1. The first semiconductor portion SMC1 may be an element constituting the first driving transistor TRD1. The portion of the first lower electrode portion LEL1 that overlaps with the first semiconductor portion SMC1 may be an element constituting the first sub-control electrode of the first driving transistor TRD1.

The second semiconductor portion SMC2 may extend from the first semiconductor portion SMC1. The second semiconductor portion SMC2 may be an element constituting the first upper light-emission transistor TRS1.

The third semiconductor portion SMC3 may be spaced apart from the first semiconductor portion SMC1 and the second semiconductor portion SMC2. The third semiconductor portion SMC3 may be an element constituting the first lower light-emission transistor TRL1.

The fourth semiconductor portion SMC4 may extend from the third semiconductor portion SMC3. The fourth semiconductor portion SMC4 may be an element constituting the first initialization transistor TRI1.

The fifth semiconductor portion SMC5 may be spaced apart from the first semiconductor portion SMC1 through the fourth semiconductor portion SMC4. The fifth semiconductor portion SMC5 may be an element constituting the first switching transistor TRW1.

The sixth semiconductor portion SMC6 may extend from the fifth semiconductor portion SMC5. The sixth semiconductor portion SMC6 may overlap with the first lower electrode portion LEL1 and the third lower electrode portion LEL3. The sixth semiconductor portion SMC6 may be an element constituting the first compensation transistor TRC1.

The seventh semiconductor portion SMC7 may be spaced apart from the first semiconductor portion SMC1 through the sixth semiconductor portion SMC6. The seventh semiconductor portion SMC7 may overlap with the first lower electrode portion LEL1.

In one or more embodiments of the present disclosure, the first through seventh semiconductor portions SMC1 through SMC7 may each be an oxide semiconductor. The oxide semiconductor may be at least one of a metal oxide semiconductor, a crystalline oxide semiconductor, or an amorphous oxide semiconductor. For example, the oxide semiconductor may include at least one of indium-tin oxide (ITO), indium-gallium-zinc oxide (IGZO), zinc oxide (ZnO), indium-zinc oxide (IZnO), zinc-indium oxide (ZIO), indium oxide (InO), titanium oxide (TiO), indium-zinc-tin oxide (IZTO), or zinc-tin oxide (ZTO).

In one or more other embodiments of the present disclosure, the first through seventh semiconductor portions SMC1 through SMC7 may each include a silicon semiconductor, which may include at least one of amorphous silicon or polycrystalline silicon. For example, the first through seventh semiconductor portions SMC1 through SMC7 may each include low-temperature polycrystalline silicon (LTPS). However, the first through seventh semiconductor portions SMC1 through SMC7 of the present disclosure are not limited to these materials and may be configured with various combinations of oxide semiconductors and silicon semiconductors.

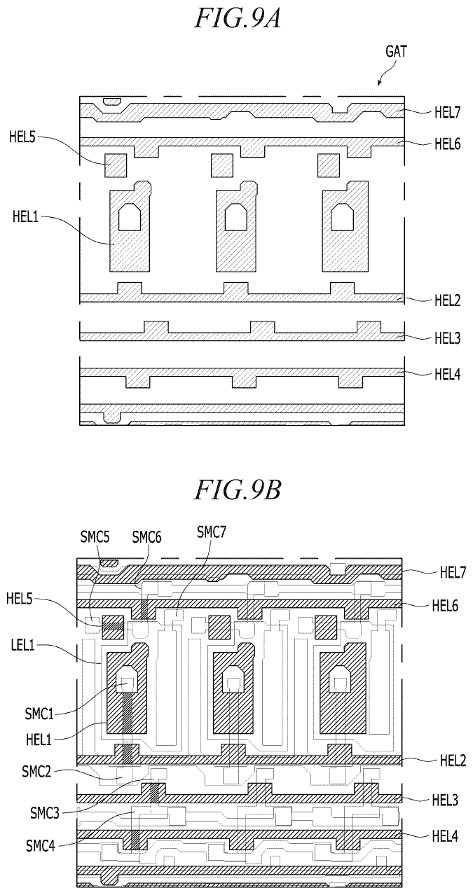

FIG. 9A is a plan view of the conductive pattern GAT, and FIG. 9B illustrates a shape in which FIG. 9A is superimposed onto FIG. 8B. Although it is depicted in FIG. 9B that the portions corresponding to FIG. 9A are darker than the portions corresponding to FIG. 8A, this depiction is for the convenience of description, and the form and color of the semiconductor pattern OACT are not limited thereto.

Referring to FIG. 9A, the conductive pattern GAT may include first through seventh upper electrode portions HEL1, HEL2, HEL3, HEL4, HEL5, HEL6, and HEL7. The conductive pattern GAT may be arranged on the semiconductor pattern OACT.

The first through seventh upper electrode portions HEL1 through HEL7 may be spaced apart from one another. Each of the first through seventh upper electrode portions HEL1 through HEL7 may overlap with or be electrically connected to at least some of the underlying patterns. Examples are provided below, but these examples are merely illustrative and do not restrict the relationships between the conductive pattern GAT and other patterns.

The first upper electrode portion HEL1 may overlap with the first lower electrode portion LEL1 and the first semiconductor portion SMC1. The portion of the first upper electrode portion HEL1 that overlaps with the first semiconductor portion SMC1 may be an element constituting the first control electrode of the first driving transistor TRD1. A first compensation capacitor CST1 may be defined in an area where the first lower electrode portion LEL1 overlaps with the first upper electrode portion HEL1.

The second upper electrode portion HEL2 may overlap with the second semiconductor portion SMC2. The portion of the second upper electrode portion HEL2 that overlaps with the second semiconductor portion SMC2 may be an element constituting the control electrode of the first upper light-emission transistor TRS1. The second upper electrode portion HEL2 may be configured to provide the first upper light-emission control signal EM1.

The third upper electrode portion HEL3 may overlap with the third semiconductor portion SMC3. The portion of the third upper electrode portion HEL3 that overlaps with the third semiconductor portion SMC3 may be an element constituting the control electrode of the first lower light-emission transistor TRL1. The third upper electrode portion HEL3 may be configured to provide the first lower light-emission control signal EMB1.

The fourth upper electrode portion HEL4 may overlap with the fourth semiconductor portion SMC4. The portion of the fourth upper electrode portion HEL4 that overlaps with the fourth semiconductor portion SMC4 may be an element constituting the control electrode of the first initialization transistor TRI1. The fourth upper electrode portion HEL4 may be configured to provide the first initialization control signal GI1.

The fifth upper electrode portion HEL5 may overlap with the fifth semiconductor portion SMC5. The portion of the fifth upper electrode portion HEL5 that overlaps with the fifth semiconductor portion SMC5 may be an element constituting the control electrode of the first switching transistor TRW1.

The sixth upper electrode portion HEL6 may overlap with the sixth semiconductor portion SMC6. The portion of the sixth upper electrode portion HEL6 that overlaps with the sixth semiconductor portion SMC6 may be an element constituting the control electrode of the first compensation transistor TRC1. The sixth upper electrode portion HEL6 may be configured to provide the first compensation control signal GC1. In one or more embodiments of the present disclosure, the sixth upper electrode portion HEL6 may be electrically connected to the fifth upper electrode portion HEL5.

The seventh upper electrode portion HEL7 may be configured to provide the first write control signal GW1.

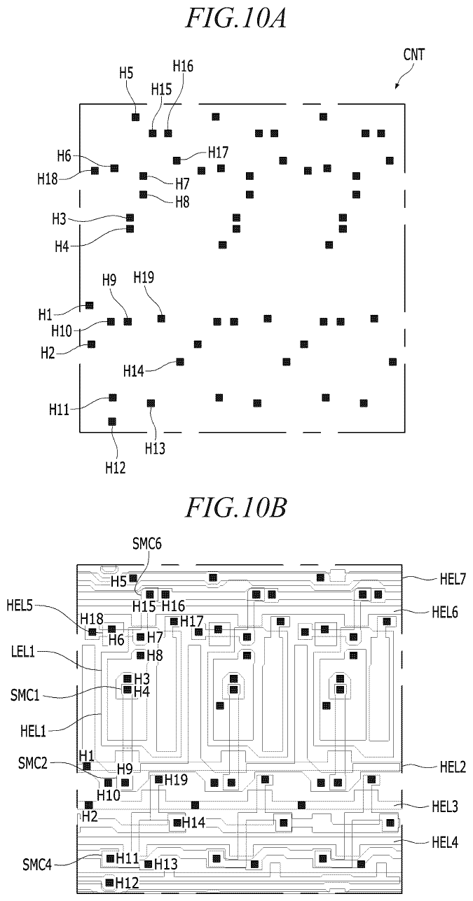

FIG. 10A is a plan view of the contact pattern CNT, and FIG. 10B illustrates a shape in which FIG. 10A is superimposed onto FIG. 9B. In FIG. 10B, the portions corresponding to FIG. 10A are depicted with a darker shade compared to the portions corresponding to FIG. 9A, but the shading is provided for the convenience of description, and the form and color of the conductive pattern GAT are not limited thereto.

Referring to FIG. 10A, the contact pattern CNT may include first through twentieth contact holes H1 through H20. The contact pattern CNT may be arranged on the conductive pattern GAT.

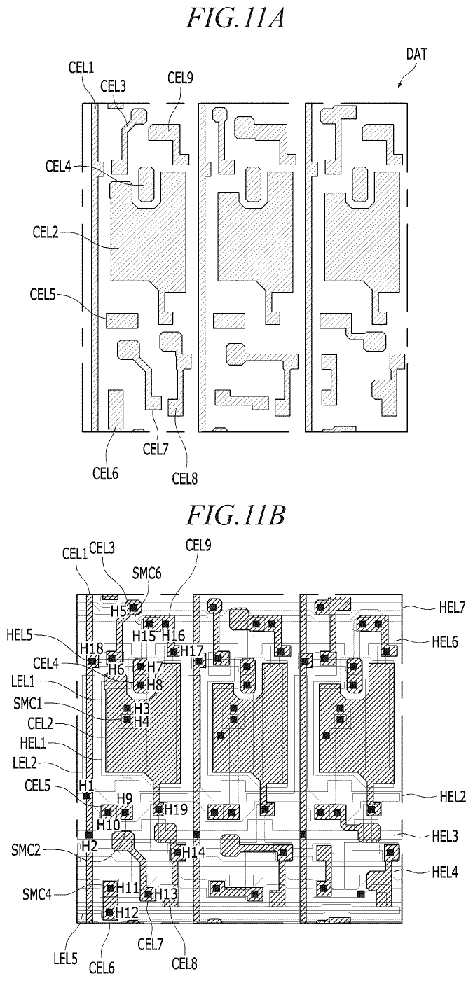

FIG. 11A is a plan view of the connection electrode pattern DAT, and FIG. 11B illustrates a shape in which FIG. 11A is superimposed onto FIG. 10B.

Referring to FIG. 11A, the connection electrode pattern DAT may include first through ninth connection electrode portions CEL1, CEL2, CEL3, CEL4, CEL5, CEL6, CEL7, CEL8, and CEL9. The connection electrode pattern DAT may be arranged on the contact pattern CNT.

Each of the first through ninth connection electrode portions CEL1 through CEL9 may contact at least one of the underlying other patterns BML, OACT, GAT through the contact holes H1 through H20. Examples are provided below, but these examples are merely illustrative, and the relationship between the connection electrode pattern DAT and other patterns is not limited to these examples.

The first connection electrode portion CEL1 may contact the second upper electrode portion HEL2 via the first contact hole H1, or may contact the third upper electrode portion HEL3 via the second contact hole H2. In other words, the first connection electrode portion CEL1 may contact the control electrode of the first upper light-emission transistor TRS1 through the first contact hole H1 or the control electrode of the first lower light-emission transistor TRL1 through the second contact hole H2.

The second connection electrode portion CEL2 may contact the first lower electrode portion LEL1 via the third contact hole H3. That is, the second connection electrode portion CEL2 may contact the first sub-control electrode of the first driving transistor TRD1 through the third contact hole H3. The second connection electrode portion CEL2 may contact the first semiconductor portion SMC1 through the fourth contact hole H4.

The third connection electrode portion CEL3 may contact the seventh upper electrode portion HEL7 via the fifth contact hole H5 and the fifth upper electrode portion HEL5 via the sixth contact hole H6. That is, the third connection electrode portion CEL3 may be configured to transfer the first write control signal GW1 to the control electrode of the first switching transistor TRW1 via the fifth contact hole H5 and the sixth contact hole H6.

The fourth connection electrode portion CEL4 may contact the sixth semiconductor portion SMC6 via the seventh contact hole H7 and the first upper electrode portion HEL1 via the eighth contact hole H8. In other words, the fourth connection electrode portion CEL4 may be configured to electrically connect the output electrode of the first compensation transistor TRC1 with the first control electrode of the first driving transistor TRD1 via the seventh contact hole H7 and the eighth contact hole H8.

The fifth connection electrode portion CEL5 may contact the second semiconductor portion SMC2 via the ninth contact hole H9 and the second lower electrode portion LEL2 via the tenth contact hole H10. In other words, the fifth connection electrode portion CEL5 may be configured to transfer the first main power signal ELVDD1 to the input electrode of the first upper light-emission transistor TRS1 via the ninth contact hole H9 and the tenth contact hole H10.

The sixth connection electrode portion CEL6 may contact the fourth semiconductor portion SMC4 via the eleventh contact hole H11 and the fifth lower electrode portion LEL5 via the twelfth contact hole H12. In other words, the sixth connection electrode portion CEL6 may be configured to transfer the first initialization signal VINT1 to the input electrode of the first initialization transistor TRI1 via the eleventh contact hole H11 and the twelfth contact hole H12.

The seventh connection electrode portion CEL7 may contact the metal pattern BML via the thirteenth contact hole H13.

The eighth connection electrode portion CEL8 may contact the third semiconductor portion SMC3 via the fourteenth contact hole H14. That is, the eighth connection electrode portion CEL8 may contact the input electrode of the first lower light-emission transistor TRL1 or the output electrode of the first lower light-emission transistor TRL1 via the fourteenth contact hole H14.

The ninth connection electrode portion CEL9 may contact the sixth semiconductor portion SMC6 via the fifteenth contact hole H15, may contact the third lower electrode portion LEL3 via the sixteenth contact hole H16, and may contact the seventh semiconductor portion SMC7 via the seventeenth contact hole H17.

In one or more embodiments of the present disclosure, the first connection electrode portion CEL1 may contact the fifth semiconductor portion SMC5 via the eighteenth contact hole H18.

In one or more embodiments of the present disclosure, the second connection electrode portion CEL2 may contact the third semiconductor portion SMC3 via the nineteenth contact hole H19.

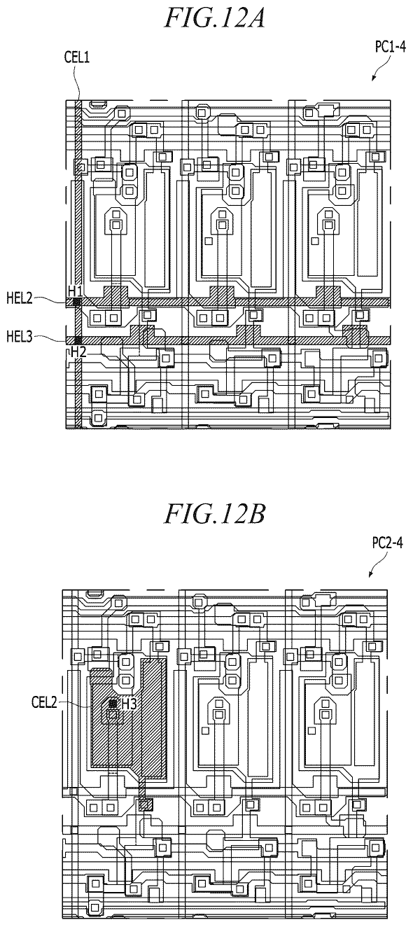

Referring to FIGS. 12A and 12B, the first connection electrode portion CEL1 of the first pixel circuit PC1-4 may be electrically connected to the second connection electrode portion CEL2 of the second pixel circuit PC2-4.

In one or more embodiments of the present disclosure, the first connection electrode portion CEL1 of the first pixel circuit PC1-4 may contact the second upper electrode portion HEL2 or the third upper electrode portion HEL3, and the second connection electrode portion CEL2 of the second pixel circuit PC2-4 may contact the first lower electrode portion LEL1. The second semiconductor portion SMC2 may be an element constituting the first upper light-emission transistor TRS1, and the third semiconductor portion SMC3 may be an element constituting the first lower light-emission transistor TRL1. The portion of the first lower electrode portion LEL1 overlapping with the first semiconductor portion SMC1 may be an element constituting the first sub-control electrode of the first driving transistor TRD1.

While certain embodiments of the present disclosure have been described above, anyone ordinarily skilled in the art to which the present disclosure pertains shall appreciate that there may be a variety of modifications and permutations of the present disclosure without departing from the technical ideas and scopes of the present disclosure that are defined in the appended claims. Moreover, it shall be appreciated that the disclosed embodiments are not intended to restrict the present disclosure thereto and that every technical idea within the appended claims and their equivalents is interpreted to be included in the scope of the present disclosure.

What is claimed is:

1. A display panel comprising:
a first pixel comprising a first light-emitting diode, and a first pixel circuit comprising:
a first driving transistor electrically connected to the first light-emitting diode, and comprising a first input electrode, a first output electrode, a first control electrode, and a first sub-control electrode; and
a first main light-emission transistor connected in series with the first driving transistor, and configured to be controlled by a first control signal; and
a second pixel comprising a second light-emitting diode, and a second pixel circuit comprising:
a second driving transistor electrically connected to the second light-emitting diode, and comprising a second input electrode, a second output electrode, a second control electrode, and a second sub-control electrode configured to receive the first control signal; and
a second main light-emission transistor connected in series with the second driving transistor.

2. The display panel of claim 1, wherein the first pixel further comprises a first data line configured to provide a first data signal,
wherein the second pixel further comprises a second data line configured to provide a second data signal,
wherein the first pixel circuit and the second pixel circuit further comprise a first switching transistor and a second switching transistor, respectively,
wherein the second switching transistor is between the second data line and the second control electrode, and
wherein a potential of the first control signal is configured to change from a first value to a second value between a time when the second switching transistor is turned on and a time when the second main light-emission transistor is turned on.

3. The display panel of claim 1, wherein the first pixel further comprises a first main power line configured to provide a first main power signal, and
wherein the first main light-emission transistor is between the first driving transistor and the first main power line, or between the first driving transistor and the first light-emitting diode.

4. The display panel of claim 3, wherein the first main light-emission transistor is between the first driving transistor and the first light-emitting diode, and
wherein the first pixel circuit further comprises a first sub-light-emission transistor between the first driving transistor and the first main power line.

5. The display panel of claim 3, wherein the first main light-emission transistor is between the first driving transistor and the first main power line, and
wherein the first pixel circuit further comprises a first sub-light-emission transistor between the first driving transistor and the first light-emitting diode.

6. The display panel of claim 1, wherein the second pixel further comprises a second main power line configured to provide a second main power signal,
wherein the first pixel circuit further comprises a first stabilization capacitor, and
wherein the second pixel circuit further comprises a second stabilization capacitor between an electrode of the second driving transistor and the second main power line.

7. The display panel of claim 1, wherein the first pixel further comprises an initialization line configured to provide a first initialization control signal,
wherein the second pixel further comprises a second initialization line configured to provide a second initialization signal,
wherein the first pixel circuit further comprises a first initialization transistor,
wherein the second pixel circuit further comprises a second initialization transistor between the second initialization line and the second light-emitting diode.

8. The display panel of claim 1, wherein the first pixel circuit further comprises a first compensation capacitor,
wherein the second pixel circuit further comprises a second compensation capacitor between the second output electrode and the second control electrode of the second driving transistor.

9. The display panel of claim 8, wherein the first pixel further comprises a first reference voltage line configured to provide a first reference voltage signal,
wherein the second pixel further comprises a second reference voltage line configured to provide a second reference voltage signal,
wherein the first pixel circuit further comprises a first compensation transistor, and
wherein the second pixel circuit further comprises a second compensation transistor between the second reference voltage line and the second compensation capacitor.

10. The display panel of claim 1, further comprising a third pixel comprising a third light-emitting diode, and a third pixel circuit comprising:
a third driving transistor electrically connected to the third light-emitting diode, and comprising a third input electrode, a third output electrode, a third control electrode, and a third sub-control electrode configured to receive a second control signal; and
a third main light-emission transistor connected in series with the third driving transistor,
wherein the first pixel further comprises a first main power line configured to provide a first main power signal,
wherein the second pixel further comprises a second main power line configured to provide a second main power signal,
wherein the first main light-emission transistor is between the first driving transistor and the first light-emitting diode, and
wherein the second main light-emission transistor is between the second driving transistor and the second main power line, and is configured to be controlled by the second control signal.

11. The display panel of claim 10, wherein the first pixel further comprises a first data line configured to provide a first data signal,
wherein the second pixel further comprises a second data line configured to provide a second data signal,
wherein the third pixel further comprises a third data line configured to provide a third data signal,
wherein the first pixel circuit further comprises a first switching transistor,
wherein the second pixel circuit further comprises a second switching transistor,
wherein the third pixel circuit further comprises a third switching transistor between the third data line and the third control electrode, and
wherein a potential of the second control signal is configured to be changed from a third value to a fourth value between a time when the third switching transistor is turned on and a time when the third main light-emission transistor is turned on.

12. The display panel of claim 11, wherein the third pixel further comprises a third main power line configured to provide a third main power signal,
wherein the third main light-emission transistor is between the third driving transistor and the third main power line, and
wherein the third pixel circuit further comprises a third sub-light-emission transistor between the third driving transistor and the third light-emitting diode.

13. The display panel of claim 11, wherein the third pixel further comprises a third main power line configured to provide a third main power signal,
wherein the third main light-emission transistor is between the third driving transistor and the third light-emitting diode, and
wherein the third pixel circuit further comprises a third sub-light-emission transistor between the third driving transistor and the third main power line.

14. The display panel of claim 13, wherein the first pixel circuit further comprises a first stabilization capacitor,
wherein the second pixel circuit further comprises a second stabilization capacitor, and
wherein the third pixel circuit further comprises a third stabilization capacitor between an electrode of the third driving transistor and the third main power line.

15. The display panel of claim 10, wherein the first pixel further comprises an initialization line configured to provide a first initialization control signal,
wherein the second pixel further comprises a second initialization line configured to provide a second initialization signal,
wherein the third pixel further comprises a third initialization line configured to provide a third initialization signal,
wherein the first pixel circuit further comprises a first initialization transistor,
wherein the second pixel circuit further comprises a second initialization transistor, and
wherein the third pixel circuit further comprises a third initialization transistor between the third initialization line and the third light-emitting diode.

16. The display panel of claim 10, wherein the first pixel circuit further comprises a first compensation capacitor,
wherein the second pixel circuit further comprises a second compensation capacitor, and
wherein the third pixel circuit comprises a third compensation capacitor between the third output electrode and the third control electrode of the third driving transistor.

17. A display panel comprising:
a first pixel comprising a first pixel circuit and a first light-emitting diode; and
a second pixel comprising a second pixel circuit and a second light-emitting diode,
wherein the first pixel circuit and the second pixel circuit comprise:
a metal pattern comprising a first lower electrode portion;
a semiconductor pattern above the metal pattern, and comprising:
a first semiconductor portion overlapping the first lower electrode portion;
a second semiconductor portion extending from the first semiconductor portion; and
a third semiconductor portion spaced apart from the first semiconductor portion and the second semiconductor portion;
a conductive pattern above the semiconductor pattern and comprising:
a first upper electrode portion overlapping the first lower electrode portion and the first semiconductor portion;
a second upper electrode portion overlapping the second semiconductor portion; and
a third upper electrode portion overlapping the third semiconductor portion, the first upper electrode portion, the second upper electrode portion, and the third upper electrode portion being spaced apart from one another; and
a connection electrode pattern above the conductive pattern and comprising:
a first connection electrode portion contacting the second upper electrode portion through a first contact hole, or contacting the third upper electrode portion through a second contact hole; and
a second connection electrode portion contacting the first lower electrode portion through a third contact hole,
wherein the first connection electrode portion of the first pixel circuit is electrically connected to the second connection electrode portion of the second pixel circuit.

18. The display panel of claim 17, wherein the metal pattern further comprises a second lower electrode portion, a third lower electrode portion, a fourth lower electrode portion, and a fifth lower electrode portion,
wherein the first lower electrode portion, the second lower electrode portion, the third lower electrode portion, the fourth lower electrode portion, and the fifth lower electrode portion are spaced apart from one another,
wherein the semiconductor pattern further comprises:
a fourth semiconductor portion extending from the third semiconductor portion;
a fifth semiconductor portion spaced apart from the first semiconductor portion, the second semiconductor portion, the third semiconductor portion, and the fourth semiconductor portion;
a sixth semiconductor portion extending from the fifth semiconductor portion, and overlapping the first lower electrode portion and the third lower electrode portion; and
a seventh semiconductor portion spaced apart from the first semiconductor portion, the second semiconductor portion, the third semiconductor portion, the fourth semiconductor portion, the fifth semiconductor portion, and the sixth semiconductor portion, and overlapping with the first lower electrode portion,
wherein the conductive pattern further comprises:
a fourth upper electrode portion overlapping the fourth semiconductor portion;
a fifth upper electrode portion overlapping the fifth semiconductor portion; and
a sixth upper electrode portion overlapping the sixth semiconductor portion, and
wherein the fourth upper electrode portion, the fifth upper electrode portion, and the sixth upper electrode portion are spaced apart from one another.

19. The display panel of claim 18, wherein the second connection electrode portion contacts the first semiconductor portion through a fourth contact hole,
wherein the connection electrode pattern further comprises:
a third connection electrode portion contacting a seventh upper electrode portion of the conductive pattern through a fifth contact hole, and contacting the fifth upper electrode portion through a sixth contact hole;
a fourth connection electrode portion contacting the sixth semiconductor portion through a seventh contact hole, and contacting the first upper electrode portion through an eighth contact hole;
a fifth connection electrode portion contacting the second semiconductor portion through a ninth contact hole, and contacting the second lower electrode portion through a tenth contact hole;
a sixth connection electrode portion contacting the fourth semiconductor portion through an eleventh contact hole, and contacting the fifth lower electrode portion through a twelfth contact hole;
a seventh connection electrode portion;
an eighth connection electrode portion; and
a ninth connection electrode portion.

20. An electronic device comprising a display panel, the display panel comprising:
a first pixel comprising a first light-emitting diode, and a first pixel circuit comprising:
a first driving transistor electrically connected to the first light-emitting diode, and comprising a first input electrode, a first output electrode, a first control electrode, and a first sub-control electrode; and
a first main light-emission transistor connected in series with the first driving transistor, and configured to be controlled by a first control signal; and
a second pixel comprising a second light-emitting diode, and a second pixel circuit comprising:
a second driving transistor electrically connected to the second light-emitting diode, and comprising a second input electrode, a second output electrode, a second control electrode, and a second sub-control electrode configured to receive the first control signal; and
a second main light-emission transistor connected in series with the second driving transistor.
